(19) United States
(12) Patent Application Publication
(10) Pub. No.: US 2026/0352349 A1
(43) Pub. Date: Nov. 5, 2026

(54) INFORMATION PROCESSING DEVICE AND INFORMATION PROCESSING METHOD

(71) Applicant: SONY GROUP CORPORATION, TOKYO (JP)

(72) Inventor: SHOTARO NODA, TOKYO (JP)

(21) Appl. No.: 19/105,046

(22) PCT Filed: Aug. 22, 2023
(86) PCT No.: PCT/JP2023/030086

§ 371 Date: Feb. 20, 2025

(30) Foreign Application Priority Data
Sep. 2, 2022 (JP) 2022-139917

(51) Int. Cl. H04B 17/318; H04B 1/3827; H04B 17/23

(52) U.S. Cl. CPC H04B 17/318; H04B 1/3833; H04B 17/23

(57) ABSTRACT

An information processing device according to an aspect of the present disclosure includes a detection unit that detects deterioration in a parameter for evaluating reception intensity by an antenna of the information processing device and a presentation unit that, when the deterioration in the parameter is detected, presents information concerning gripping of the information processing device according to the deterioration in the parameter.

### FIELD

The present invention relates to an information processing device and an information processing method.

### BACKGROUND

In a terminal device that is premised to be held and used by a user (for example, a mobile phone terminal) , there is a problem in that an antenna is covered with a hand and communication performance is deteriorated depending on how the user holds the terminal device. The deterioration in the communication performance sometimes causes hindrance to use of an application or deterioration in a download time.

Incidentally, in Patent Literature 1, focusing on a point that, in order to suppress deterioration of antenna characteristics, it is necessary to grasp how a portable wireless device is held, first reception intensity before a user performs specific operation and second reception intensity after the user performs the specific operation are compared to discriminate how the user holds the portable wireless device.

### CITATION LIST

### Patent Literature

Patent Literature 1: JP 2012-182592 A

### SUMMARY

### Technical Problem

According to the related art described above, for example, while it is possible to discriminate, at low cost, how the user holds the terminal device, there is room for improvement in effectively preventing deterioration of communication performance. For example, since a way of holding depends on a user, in order to effectively prevent deterioration of communication performance, it is considered necessary to first give the user awareness concerning the way of holding.

However, in the related art described above, for example, matching between antennas is merely adjusted according to the determined way of holding. It is not always possible to effectively prevent deterioration in communication performance.

Therefore, the present disclosure proposes an information processing device and an information processing method that can effectively prevent deterioration inf communication performance.

### Solution to Problem

In order to solve the above problems, one aspect of An information processing device comprising: a detection unit that detects deterioration in a parameter for evaluating reception intensity by an antenna of the information processing device; and a presentation unit that, when the deterioration in the parameter is detected, presents information concerning gripping of the information processing device according to the deterioration in the parameter.

### BRIEF DESCRIPTION OF DRAWINGS

FIG. 1 is a block diagram illustrating an overview of a terminal device.

FIG. 2 is a diagram illustrating a configuration of a system according to a first embodiment.

FIG. 3 is a diagram illustrating a configuration example of a terminal device according to the first embodiment.

FIG. 4 is a diagram illustrating a disposition example of antennas in the terminal device according to the first embodiment.

FIG. 5 is a flowchart illustrating a preprocessing procedure according to the first embodiment.

FIG. 6 is a flowchart illustrating an estimation processing procedure according to the first embodiment.

FIG. 7 is a diagram illustrating a specific example of estimation processing according to the first embodiment.

FIG. 8 is a diagram illustrating an example of linkage between active antennas and transition information.

FIG. 9 is a diagram (1) illustrating an example of a user interface.

FIG. 10 is a diagram (2) illustrating an example of a user interface.

FIG. 11 is a diagram (3) illustrating an example of a user interface.

FIG. 12 is a flowchart illustrating a control procedure relating to output stop of the user interface.

FIG. 13 is an explanatory diagram for explaining a parameter restoration determination method.

FIG. 14 is a diagram illustrating a configuration of a system according to a second embodiment.

FIG. 15 is a diagram illustrating an example of a learning method of a model for estimating a holding pattern.

FIG. 16 is a flowchart illustrating an estimation processing procedure according to the second embodiment.

FIG. 17 is a block diagram illustrating a hardware configuration example of a computer corresponding to a terminal device according to an embodiment of the present disclosure.

### DESCRIPTION OF EMBODIMENTS

An embodiment of the present disclosure is explained in detail below with reference to the drawings. Note that an information processing device and an information processing method according to the present disclosure are not limited by the embodiment. In the embodiment explained below, the same parts are denoted by the same reference numerals and signs to omit redundant explanation.

### Embodiment

### 1. Introduction

An information processing device according to a proposed technology of the present disclosure presents (proposes) information concerning gripping in response to a problem in that communication by an antenna is disturbed and communication performance is deteriorated depending on how a user holds the information processing device, thereby giving awareness about a point that there is a problem in a way of holding. With such an information processing device, it is possible to effectively prevent deterioration in communication performance.

In the following explanation, the embodiment is explained using a terminal device 10 that is an example of the information processing device in the present disclosure. Information processing according to the embodiment can be roughly divided into estimation preprocessing, factor estimation processing, and presentation processing. In the following explanation, first, an overall image of such information processing is explained.

### 2. Overall Image of Information Processing

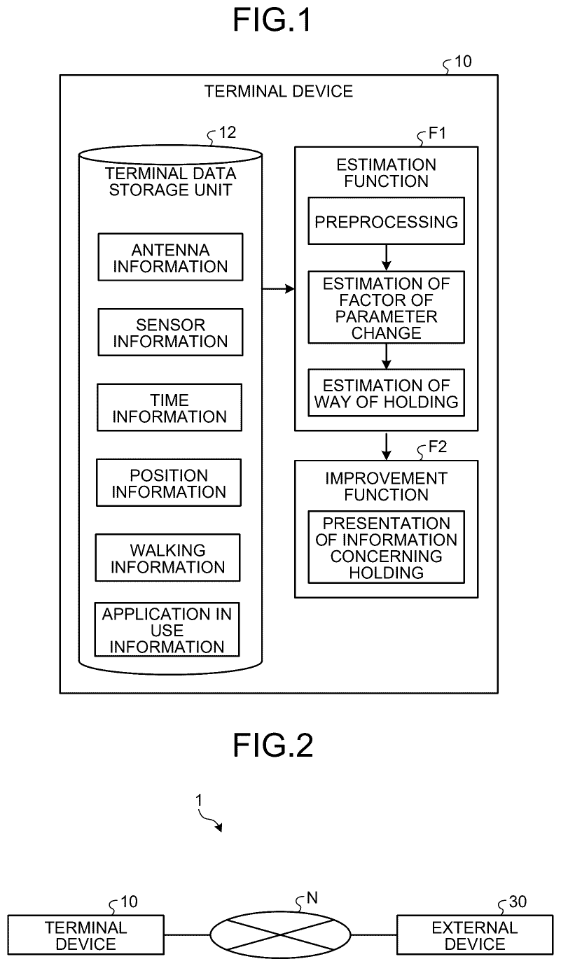

An overall image of information processing according to an embodiment is explained with reference to FIG. 1. FIG. 1 is a block diagram illustrating an overview of the terminal device 10.

The terminal device 10 is an information processing terminal used by a user. The terminal device 10 is realized by, for example, a smartphone, a tablet terminal, a notebook PC (Personal Computer), a desktop PC, a mobile phone, or a PDA (Personal Digital Assistant). In the present embodiment, the terminal device 10 is assumed to be a smartphone.

An application for implementing information processing according to the embodiment may be introduced into the terminal device 10. That is, the terminal device 10 may operate according to an application for implementing the information processing according to the embodiment. Such an application may be implemented as a dedicated application or may be a general-purpose application such as a browser.

According to an example illustrated in FIG. 1, the terminal device 10 has an estimation function F1 for performing estimation processing and an improvement function F2 for promoting improvement of communication performance. These functions perform processing using predetermined terminal data included in the terminal device 10.

### Terminal Data

The terminal data is stored in a terminal data storage unit 12 and may include, for example, antenna information, sensor information, time information, position information, walking information, and application in use information. Naturally, the terminal data is not limited to such an example.

The antenna information is information concerning an antenna included in the terminal device 10. For example, the antenna information includes a parameter for evaluating reception intensity by the antenna. Examples of the parameter include RSRP (Reference Signal Received Power), RSRQ (Reference Signal Received Quality), RSSI (Received Signal Strength Indicator), and SNR (Signal-to-Noise Ratio).

The antenna information may also include a frequency band used by the antenna and a bit error rate (BER) corresponding to the antenna.

The sensor information may be information acquired by a sensor included in the terminal device 10 and may include detection information by an acceleration sensor, detection information by a gyro sensor, detection information by a GPS sensor, detection information by a temperature sensor, and detection information by a timer.

The time information is information indicating the present time. The position information is information indicating a current position of the terminal device 10 (or a user of the terminal device 10). The walking information is information indicating whether the user of the terminal device 10 is currently walking.

The application in use information is information concerning an application being used (started) among applications installed in the terminal device 10.

### Estimation Function F1

According to the example illustrated in FIG. 1, the estimation function F1 executes, as preprocessing for the estimation processing, processing of determining whether to execute estimation processing explained below based on terminal data. When it is determined by the preprocessing that the estimation processing should be executed, the estimation function F1 detects a change in a parameter (deterioration in the parameter) based on the terminal data and, where detecting a change in the parameter, executes the estimation processing of estimating a factor of the change in the parameter. For example, the estimation function F1 estimates whether the terminal device 10 is gripped in a mode of disturbing communication by an antenna.

The estimation function F1 may also perform, based on the terminal data, processing of estimating how the user holds the terminal device 10.

### Improvement Function F2

The improvement function F2 is equivalent to a function of improving a way of holding by presenting information concerning gripping of the terminal device 10 according to an estimation result by the estimation function F1. For example, when the terminal device 10 is gripped in a mode of disturbing the communication by the antenna, the improvement function F2 causes the terminal device 10 to output a user interface for warning not to cover a target antenna that is a target of the disturbance.

When a way of holding recommended when an application started in the terminal device 10 is used and a current way of holding by the user are different, the improvement function F2 may also perform processing of presenting a recommended way of holding.

Note that, in the present embodiment, the expression “holding” can include not only a state of holding to grip the terminal device 10 but also any way of holding if the way of holding is a mode of touching the terminal device 10. For example, the “gripping” also includes the concept of “holding”.

The overall image of the information processing according to the embodiment is explained above with reference to FIG. 1. In the following explanation, the embodiment is divided into a first embodiment and a second embodiment and explained. Specifically, the first embodiment corresponds to general-purpose information processing not using machine learning and the second embodiment corresponds to adaptive information processing using machine learning.

### First Embodiment

### 1-1. System Configuration

FIG. 2 is a diagram illustrating a configuration of a system according to the first embodiment. FIG. 1 illustrates an information processing system 1 serving as an example of the system according to a first embodiment.

As illustrated in FIG. 2, the information processing system 1 may include the terminal device 10 and an external device 30. The terminal device 10 and the external device 30 may be communicably connected by wire or by radio via a network N.

Here, the external device 30 may be, for example, a wearable device owned by a user of the terminal device 10. The terminal data explained with reference to FIG. 1 is so-called data in the terminal device 10 (intra-terminal data). However, data acquired by the external device 30 may also be utilized as the terminal data. For example, when the external device 30 includes a sensor not included in the terminal device 10, the terminal device 10 may acquire sensor information detected by such a sensor from the external device 30 and store the sensor information in the terminal data storage unit 12.

### 1-2. Configuration of the Terminal Device

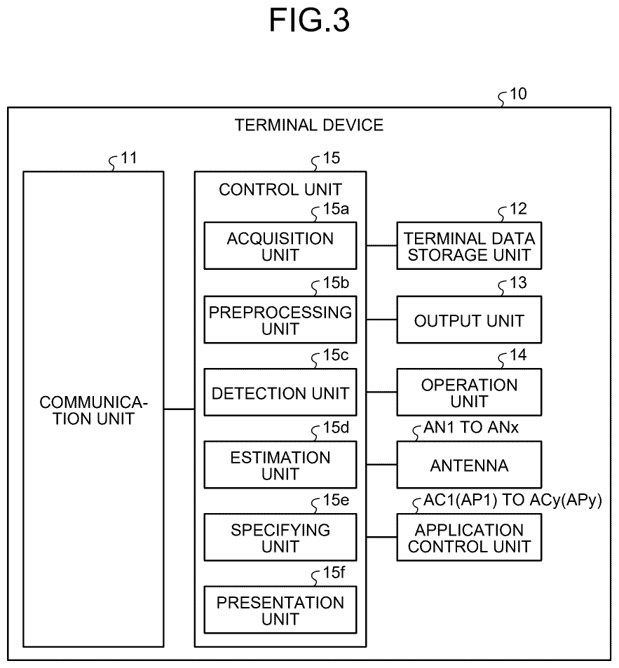

FIG. 3 is a diagram illustrating a configuration example of the terminal device 10 according to the first embodiment. As illustrated in FIG. 3, the terminal device 10 according to the first embodiment includes a communication unit 11, a terminal data storage unit 12, an output unit 13, an operation unit 14, antennas AN1 to ANx, and application control units AC1 to ACy.

### Communication Unit 11

The communication unit 11 is implemented by, for example, an NIC (Network Interface Card). For example, the communication unit 11 is connected to the network N by radio and, for example, transmits and receives information to and from the external device 30.

### Terminal Data Storage Unit 12

The terminal data storage unit 12 stores the various terminal data (intra-terminal data) explained with reference to FIG. 1. The terminal data storage unit 12 may store, as terminal data, data acquired from the external device 30.

### Output Unit 13

The output unit 13 is a display screen implemented by, for example, a liquid crystal display or an organic EL (Electro-Luminescence) display and may be a display device for displaying various kinds of information. The output unit 13 is not limited to the display screen and may be, for example, a speaker that outputs sound.

### Operation Unit 14

The operation unit 14 functions as an input unit that receives various kinds of operation of the user. The operation unit 14 receives, for example, operation for information displayed by the output unit 13 from the user of the terminal device 10.

### Antennas AN1 to ANx

The antennas AN1 to ANx are antennas included in the terminal device 10. Such an example indicates an example in which x antennas, that is, the antenna AN1, the antennas AN2, . . . and the antenna ANx are provided in the terminal device 10. Note that, when it is unnecessary to distinguish the antennas AN1 to ANx included in the terminal device 10, the antennas AN1 to ANx are simply referred to as antennas ANx.

### Application Control Units AC1 to ACy

The application control units AC1 (AP1) to ACy (APy) are control functions corresponding to applications installed in the terminal device 10. Such an example indicates an example in which y applications, that is, the application AP1, the applications AP2, . . . , and the application APy are installed in the terminal device 10 and, accordingly, the application control unit AC1 corresponding to the application AP1, the application control unit AC2 corresponding to the application AP2, . . . , and the application control unit ACy corresponding to the application APy are loaded.

Note that, when it is unnecessary to distinguish the applications AP1 to APy installed in the terminal device 10, the applications AP1 to APy are simply referred to as applications APy. Similarly, when it is unnecessary to distinguish the application control units AC1 to ACy included in the terminal device 10, the application control units AC1 to ACy are simply referred to as application control units ACy.

### Control Unit 15

The control unit 15 is implemented by various programs stored in a storage device inside the terminal device 10 being executed by a CPU (Central Processing Unit), an MPU (Micro Processing Unit), or the like using a RAM (Random Access Memory) as a work area. The control unit 15 is implemented by an integrated circuit such as an ASIC (Application Specific Integrated Circuit) or an FPGA (Field Programmable Gate Array).

As illustrated in FIG. 3, the control unit 15 includes an acquisition unit 15a, a preprocessing unit 15b, a detection unit 15c, an estimation unit 15d, a specifying unit 15e, and a presentation unit 15f and implements or executes functions and action of information processing explained below. Note that an internal configuration of the control unit 15 is not limited to the configuration illustrated in FIG. 3 and may be another configuration ifs information processing explained below is performed. A connection relation among the processing units included in the control unit 15 is not limited to the connection relation illustrated in FIG. 3 and may be another connection relation.

### Acquisition Unit 15a

The acquisition unit 15a acquires terminal data obtained according to an operation of the terminal device 10 and stores the acquired terminal data in the terminal data storage unit 12. For example, the acquisition unit 15a may acquire antenna information in response to transmission and reception of radio waves by the antenna ANx included in the terminal device 10. The acquisition unit 15a may acquire sensor information in response to detection by various sensors included in the terminal device 10. The acquisition unit 15a may acquire information concerning the started application APy (application in use information) in response to the start of the application APy by the user.

### Preprocessing Unit 15b

The preprocessing unit 15b performs processing serving as a pre-stage of estimation processing of estimating a factor of a change in a parameter. Specifically, the preprocessing unit 15b determines in advance whether estimation processing of estimating a factor of a change in a parameter is necessary. As a result, the preprocessing unit 15b can prevent, for example, power consumption from increasing because unnecessary estimation processing is executed.

### Detection Unit 15c

The detection unit 15c detects a change in a parameter for evaluating reception intensity by the antenna ANx. For example, the detection unit 15c detects a change in the parameter based on transition information indicating a transition of the parameter. For example, the detection unit 15c detects a deterioration in the parameter as a change in the parameter.

### Estimation Unit 15d

When a change in the parameter is detected, the estimation unit 15d estimates a factor of the change in the parameter based on transition information corresponding to the respective antennas ANx. In the first embodiment, the estimation unit 15d detects a difference in transition information among the antennas ANx by comparing the transition information corresponding to the respective antennas ANx and estimates a factor of the change in the parameter based on a detection

When estimating, as a factor of the change in the parameter, a gripping state in a mode of disturbing the communication by the antennas ANx (that the terminal device 10 has been gripped in a mode of disturbing the communication by the antennas ANx), the estimation unit 15d executes processing for causing the presentation unit 15f to present information concerning the gripping of the terminal device 10. Here, the gripping state in the mode of disturbing the communication by the antennas ANx indicates, for example, a way of holding the antenna ANx to cover the antennas ANx with fingers or a palm.

### Specifying Unit 15e

The specifying unit 15e specifying, among the antennas ANx, an antenna, communication to which is disturbed by the user, that is, a target antenna that is a target of disturbance. For example, the specifying unit 15e may specify, based on transition information, active antennas that are antennas used for current communication among the antennas ANx and specify the target antenna out of the specified active antennas.

The specifying unit 15e may further specify disposition positions of the antennas ANx in the terminal device 10 based on terminal data.

### Presentation Unit 15f

When a change in the parameter is detected, the presentation unit 15f presents information concerning gripping of the terminal device 10 according to the change in the parameter. For example, 15f performs control such that a user interface for warning not to cover a disposition positions of the target antenna that is the target of disturbance is output from the output unit 13.

For example, the presentation unit 15f may output, as the user interface, a window imitating the terminal device 10 and indicating the disposition position of the target antenna to a predetermined position on the display screen of the terminal device 10. The presentation unit 15f may output, as the user interface, antenna position information suggesting the disposition position of the target antenna to a position near the disposition position of the target antenna among positions in the display screen of the terminal device 10. The presentation unit 15f may output a user interface in a voice format or a vibration format.

When it is determined based on the transition information that the factor of the change in the parameter has been improved, the presentation unit 15f may stop presenting the user interface.

### 1-3. Antennas Included in the Terminal Device

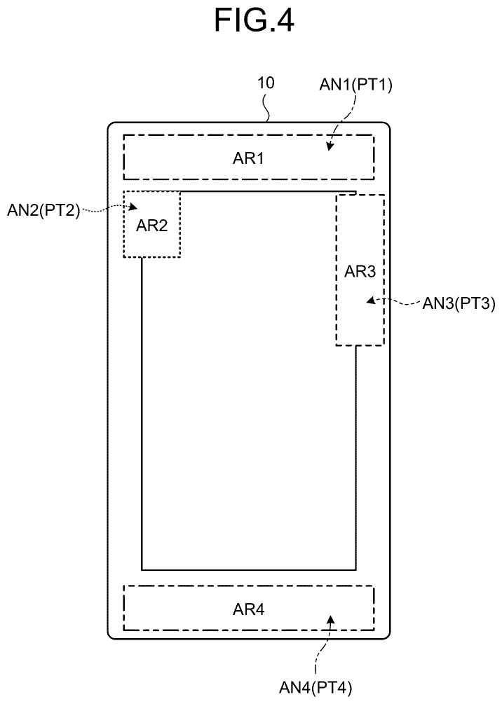

Subsequently, a disposition example of the antennas ANx in the terminal device 10 is explained with reference to FIG. 4. FIG. 4 is a diagram illustrating the disposition example of the antennas ANx in the terminal device 10 according to the first embodiment. In FIG. 4, a disposition example of the antennas AN1 to AN4 is explained assuming that the terminal device 10 includes the antennas AN1, AN2, AN3, and AN4 (the antennas AN1 to AN4).

FIG. 4 illustrates an example in which the antenna AN1 is disposed at a position PT1 inside the terminal device 10 and the antenna AN2 is disposed at a position PT2 inside the terminal device 10. FIG. 4 illustrates an example in which the antenna AN3 is disposed at a position PT3 inside the terminal device 10 and the antenna AN4 is disposed at a position PT4 inside the terminal device 10.

Note that the disposition positions of the antennas ANx may be defined using a coordinate system corresponding to the terminal device 10. The disposition positions of the antennas ANx may be defined by ranges. For example, a position P1 may be information indicating a position of a range AR1 occupied by the antenna AN1. A position P2 may be information indicating a position of a range AR2 occupied by the antenna AN2. A position P3 may be information indicating a position of a range AR3 occupied by the antenna AN3. A position P4 may be information indicating a position of a range AR4 occupied by the antenna AN4.

In the following explanation, it is assumed that the terminal device 10 according to the first embodiment includes the antennas AN1, AN2, AN3, and AN4 and these antennas are disposed in a positional relations illustrated in FIG. 4.

### 1-4. Procedure of the Preprocessing

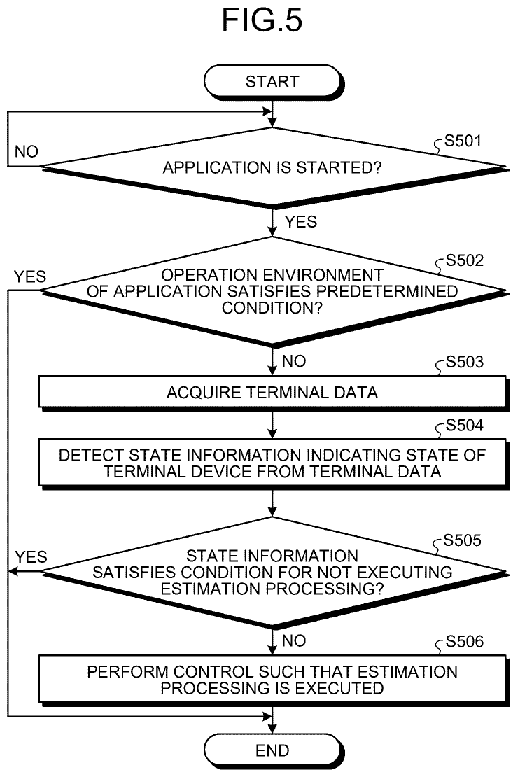

Subsequently, a procedure of the preprocessing according to the first embodiment is explained with reference to FIG. 5. FIG. 5 is a flowchart illustrating the preprocessing procedure according to the first embodiment.

The preprocessing unit 15b determines whether any one of the applications APy installed in the terminal device 10 is started and is in use (Step S501). For example, the preprocessing unit 15b may determine, based on application in use information acquired via the application control unit ACy, whether any one of the applications APy is started and in use. While none of the applications APy is started (Step S501; No), the preprocessing unit 15b stays on standby until any of the applications APy is started.

On the other hand, when any one of the applications APy is started (Step S501; Yes), the preprocessing unit 15b determines, based on application in use information corresponding to the started application APy, whether an operation environment for causing the application APy to operate satisfies a predetermined condition (Step S502). For example, the preprocessing unit 15b may determine whether minimum communication speed required to cause the application APy to operate is less than a threshold. The preprocessing unit 15b may determine whether the application APy is an application that does not require a low delay mode.

When the operation environment for causing the application APy to operate satisfies the predetermined condition (Step S502; Yes), the preprocessing unit 15b may determine that the estimation processing is unnecessary and end the processing without executing the estimation processing. In the example explained above, the preprocessing unit 15b may determine that the estimation processing is unnecessary when determining in Step S502 that the minimum communication speed required to cause the application APy to operate is less than the threshold or when the application APy is an application that does not require the low delay mode.

Note that, in Step S502, the preprocessing unit 15b may combine determinations as to whether the terminal device 10 is put in the user's clothes, bag, or the like, whether a communication status of the terminal device 10 is out of range, whether the terminal device 10 is set to a flight mode, whether a screen is locked, whether the started application APy is an application that does not need to communicate in the first place, and the like.

As another example, in Step S502, the preprocessing unit 15b may combine processing of determining whether the started application APy is an application less affected by deterioration in communication performance.

For example, it is assumed that the started application APy is an FPS (First Person Shooter) game application. In the FPS game application, it is considered that play is greatly hindered under a situation in which the communication performance is poor. For this reason, when the started application APy is the FPS game application, the preprocessing unit 15b may advance the processing to Step S503 based on the determination that the estimation processing is necessary.

On the other hand, for example, it is assumed that the started application APy is a message application. In the message application, it is considered that there is little hindrance to exchange even in a situation where the communication performance is somewhat poor. For this reason, when the started application APy is a message application, the preprocessing unit 15b may determine that the estimation processing is unnecessary and end the processing without executing the estimation processing.

As explained above, by performing the processing of Step S502, the preprocessing unit 15b can perform control such that unnecessary estimation processing is not executed. Therefore, for example, power consumption by the terminal device 10 can be suppressed.

Subsequently, when the operation environment for causing the application APy to operate does not satisfy the predetermined condition (Step S502; No), the preprocessing unit 15b acquires terminal data from the terminal data storage unit 12 (Step S503).

The preprocessing unit 15b detects, based on the acquired terminal data, state information indicating a state of the terminal device 10 (Step S504). Then, the preprocessing unit 15b determines whether the detected state information satisfies a condition for not executing the estimation processing (Step S505).

For example, the preprocessing unit 15b may detect the moving speed of the terminal device 10 from the terminal data and, when the detected moving speed exceeds predetermined speed, determine, based on the determination that the terminal device 10 is placed in an environment in which communication performance is likely to deteriorate (a deterioration in throughput due to handover), that the condition for not executing the estimation processing is satisfied (Step S505; Yes) and end the processing.

The preprocessing unit 15b may detect the direction of the terminal device 10 from the terminal data and, when the detected direction suggests deterioration in the communication performance due to directivity of an antenna, determine, based on the determination that the terminal device 10 is placed in an environment in which communication performance is likely to deteriorate, that the condition for not executing the estimation processing is satisfied (Step S505; Yes) and end the processing.

The preprocessing unit 15b may detect the temperature of the terminal device 10 from the terminal data and, when the detected temperature exceeds a predetermined temperature, determine, based on determination that the communication performance is deteriorated because of heat generation, that the condition for not executing the estimation process is satisfied (Step S505; Yes) and end the processing.

When the height (the altitude) of the terminal device 10 exceeds a predetermined value from the terminal data, the preprocessing unit 15b may determine, based on determination that the communication performance is deteriorated by the altitude, that the condition for not executing the estimation processing is satisfied (Step S505; Yes) and end the processing.

As explained above, by performing the processing of Step S505, the preprocessing unit 15b can perform control such that the estimation processing is not executed under a situation in which it is estimated that the degradation in the communication performance is unavoidable. Therefore, it is possible to omit unnecessary estimation processing and suppress power consumption by the terminal device 10. That is, the preprocessing unit 15b can perform control such that unnecessary estimation processing is not executed under a situation in which there is a high possibility that the communication performance is deteriorated because of another factor (for example, an environmental factor) that is not a way of holding that disturb the communication by the antennas ANx.

On the other hand, when determining that the detected state information does not satisfy the condition for not executing the estimation processing (Step S505; No), the preprocessing unit 15b performs control such that estimation processing of estimating a factor of a change in a parameter is executed (Step S506).

### 1-5. Procedure of the Estimation Processing

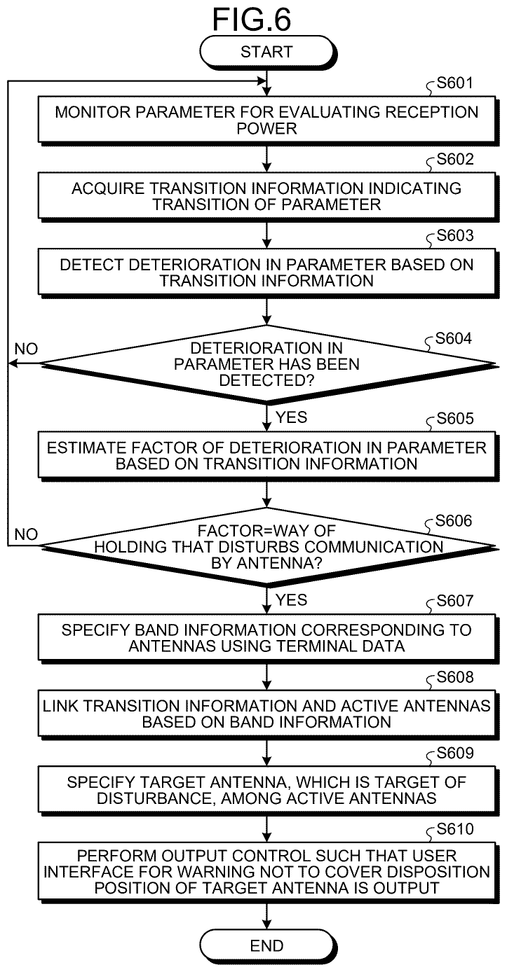

Subsequently, a procedure of the estimation processing actually performed in response to the estimation processing being controlled to be executed as a result of the preprocessing explained with reference to FIG. 5 is explained with reference to FIG. 6. FIG. 6 is a flowchart illustrating an estimation processing procedure according to the first embodiment.

The detection unit 15c monitors a parameter for evaluating a reception level of a radio wave by the antennas ANx (Step S601). For example, the detection unit 15c may monitor any one of RSRP, RSRQ, RSSI, and SNR.

Then, the detection unit 15c acquires transition information (an example of information concerning the parameter) indicating transition of the parameter according to the monitoring of the parameter (Step S602). The transition information indicating the transition of the parameter is a temporal change of the parameter and is temporal data indicating a temporal change corresponding to continuously executed monitoring.

Subsequently, the detection unit 15c detects deterioration in the parameter based on the transition information (Step S603). The detection unit 15c determines whether deterioration in the parameter has been detected (Step S604). While deterioration in the parameter has not been detected (Step S604; No), the detection unit 15c repeats the processing from Step S601 until deterioration in the parameter is detected.

On the other hand, when deterioration in the parameter has been detected (Step S604; Yes), the estimation unit 15d executes, based on the transition information, estimation processing of estimating a factor of the deterioration in the parameter (Step S605).

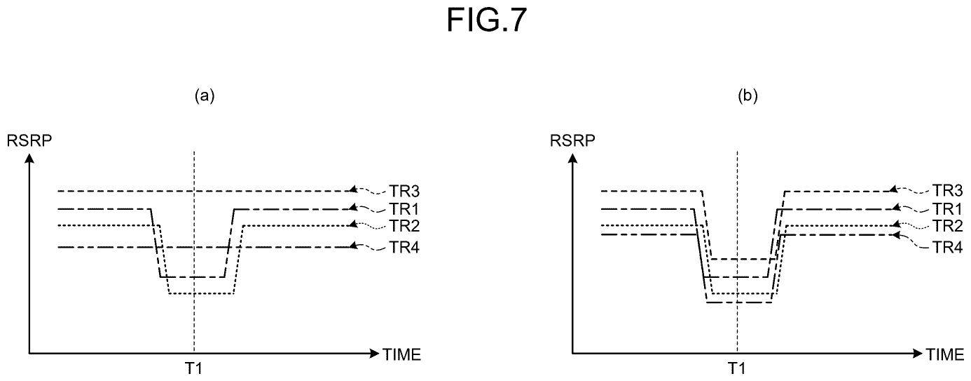

Here, a specific example of the estimation processing performed between the detection unit 15c and the estimation unit 15d is explained with reference to FIG. 7. FIG. 7 is a diagram illustrating a specific example of estimation processing according to the first embodiment. FIG. 7 illustrates transition information (temporal data of an RSRP) of the respective antennas ANx in use when the RSRP is monitored as a parameter. As explained above, transition information corresponding to active antennas that is an antenna used for current communication among the antennas AN1 to AN4 is acquired. However, at the present time, it is unclear which one of the antennas AN1 to AN4 is the active antennas.

Specifically, FIG. 7 illustrates four pieces of transition information, that is, transition information TR1, TR2, TR3, and TR4. However, the transition information TR1, TR2, TR3, and TR4 and the active antennas among the antennas AN1 to AN4 are not associated at this time. That is, at a stage of the estimation processing, it is unclear to which active antennas among the antennas AN1 to AN4 included in the terminal device 10 the respective kinds of transition information TR1 to TR4 obtained at this time correspond.

In such a state, the detection unit 15c detects deterioration in the RSRP based on the transition information TR1 to TR4. For example, when there is a section in which a degree of deterioration is equal to or greater than a threshold in an elapsed time, the detection unit 15c may detect the deterioration in the RSRP.

According to an example illustrated in FIG. 7(a), deterioration in the transition information TR1 and TR2 is seen in a specific section including time T1. It is assumed that the degree of the deterioration is equal to or greater than the threshold. In such a case, the detection unit 15c detects the deterioration in the RSRP for the transition information TR1 and detects the deterioration in the RSRP for the transition information TR2.

In the example illustrated in FIG. 7(a), the estimation unit 15d estimates a factor of the deterioration in the RSRP in response to the detection of the deterioration in the RSRP by the detection unit 15c. Specifically, the estimation unit 15d estimates whether the RSRP has been deteriorated because the terminal device 10 has been gripped in a mode of disturbing the communication by the antennas ANx or whether the RSRP has been deteriorated because of other factors.

For example, the estimation unit 15d compares the transition information TR1, the transition information TR2, the transition information TR3, and the transition information TR4. By such comparison, the estimation unit 15d detects a difference in a pattern among transition patterns formed by the respective kinds of transition information TR1 to TR4.

In the example illustrated in FIG. 7(a), the estimation unit 15d can detect a difference in that a pattern indicating a trough of the deterioration is included in only a part of the transition patterns formed by the respective kinds of transition information TR1 to TR4. Specifically, the estimation unit 15d can detect a difference in that a pattern indicating a trough of deterioration is included only in two transition patterns, that is, a transition pattern corresponding to the transition information TR1 and a transition pattern corresponding to the transition information TR2.

As explained above, when a pattern indicating a trough of deterioration is detected only in a part of the transition patterns among the transition patterns formed by the respective kinds of transition information TR1 to TR4, the estimation unit 15d may estimate a gripping state in a mode of disturbing the communication by the antennas ANx as a factor of the deterioration in the RSRP. In other words, the estimation unit 15d may estimate that the RSRP has been deteriorated because the terminal device 10 has been gripped in a mode of interfering with communication by the antennas ANx.

Subsequently, an example illustrated in FIG. 7(b) is explained. FIG. 7(b) illustrates an example different from the example illustrated in FIG. 7(a). According to the example illustrated in FIG. 7(b), in a specific section including the time T1, deterioration is seen in all of the kinds of transition information TR1 to TR4. It is assumed that the degree of the deterioration is equal to or greater than the threshold. In such a case, the detection unit 15c detects deterioration in the RSRP for all of the pieces of transition information TR1 to TR4.

In the example illustrated in FIG. 7(b), the estimation unit 15d estimates a factor of the deterioration in the RSRP in response to detection of the deterioration in the RSRP by the detection unit 15c. However, an estimation method is as explained with reference to FIG. 7(a). However, in the example of FIG. 7(b), in all of the kinds of transition information TR1 to TR4, both of sections of deterioration and degrees of the deterioration are common or similar. In such an example, the estimation unit 15d cannot substantially detect a difference in a pattern among the transition patterns formed by the respective kinds of transition information TR1 to TR4.

As explained above, when a difference cannot be detected among the transition patterns formed by the respective kinds of transition information TR1 to TR4, the estimation unit 15d may estimate, as a factor of the deterioration in the RSRP, some factor other than the gripping state in the mode of disturbing the communication by the antennas ANx. In other words, the estimation unit 15d may estimate that the RSRP has been deteriorated because of another factor unrelated to a way of holding the terminal device 10 by the user. For example, the estimation unit 15d may estimate that the RSRP has been deteriorated because of an environmental factor other than a way of holding the terminal device 10 by the user.

Returning back to FIG. 6, the estimation unit 15d determines, based on an estimation result, whether a gripping state (a holding way) in a mode of disturbing the communication by the antennas ANx is a factor of the deterioration in the parameter (Step S606). When determining that the gripping state (the holding way) in the mode of disturbing the communication by the antennas ANx is not a factor of the deterioration in the parameter (Step S606; No), the estimation unit 15d repeats the processing from Step S601.

On the other hand, when it is determined that the gripping state in the mode of disturbing the communication by the antennas ANx is a factor of the deterioration in the parameter, the specifying unit 15e specifies, based on the terminal data, band information (frequency bands) corresponding to the respective antennas AN1 to AN4 (Step S607).

The specifying unit 15e links, based on the band information and the terminal data, active antennas, which are antennas used for current communication, among the antennas AN1 to AN4, and the transition information TR1 to TR4 (Step S608). For example, the terminal data may also include information concerning a communication standard or a communication scheme of the antennas ANx. The specifying unit 15e links the band information specified for the respective antennas AN1 to AN4 and the transition information TR1 to TR4 by collating the band information and the information concerning the communication standard or the communication scheme. As a result, the specifying unit 15e can specify the active antennas, which are the antennas used for the current communication, among the antennas AN1 to AN4. Therefore, finally, it is possible to link the respective specified active antennas and the transition information TR1 to TR4.

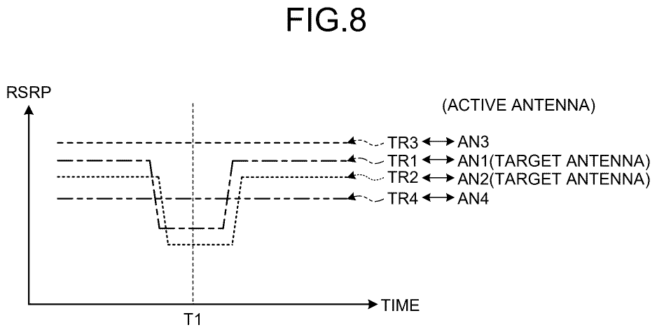

Here, FIG. 8 illustrates an example of linkage between the active antennas and the transition information TR1 to TR4. FIG. 8 is a diagram illustrating the example of linkage between the active antennas and the transition information TR1 to TR4. FIG. 8 illustrates an example in which information concerning the active antennas is linked with the transition information TR1 to TR4 in the state illustrated in FIG. 7(a) in response to the determination that the gripping state in the mode of disturbing the communication by the antennas ANx is a factor of the deterioration in the parameter based on the transition pattern of FIG. 7(a).

As a simple example, FIG. 8 illustrates an example in which the specifying unit 15e specifies the respective antennas AN1 to AN4 as the active antennas and links the transition information TR1 and the antenna AN1, the transition information TR2 and the antenna AN2, the transition information TR3 and the antenna AN3, and the transition information TR4 and the antenna AN4.

Subsequently, the specifying unit 15e specifies a target antenna, which is a target of disturbance, among the active antennas based on a linkage result in Step S608 (Step S609). When the example illustrated in FIG. 8 is used, the specifying unit 15e specifies, as the target antenna, the antenna AN1 linked as the active antenna with the transition information TR1 in which a pattern indicating the deterioration in the parameter (the RSRP) is detected. The specifying unit 15e specifies, as the target antenna, the antenna AN2 linked as the active antenna with the transition information TR2 in which the pattern indicating the deterioration in the parameter (the RSRP) is detected.

Subsequently, the presentation unit 15f performs output control such that a user interface for warning not to cover a disposition position of the target antenna in the terminal device 10 is output (Step S610). For example, the presentation unit 15f may perform the output control such that a window imitating the terminal device 10 and indicating the disposition position of the target antenna is output to a predetermined position on the display screen (the output unit 13) of the terminal device 10 as the user interface.

The presentation unit 15f may perform the output control such that antenna position information suggesting the disposition position of the target antenna is output as the user interface to a position near the disposition position of the target antenna among positions in the display screen of the terminal device 10.

The presentation unit 15f may adopt, as an output scheme for the user interface, sound output via a speaker (the output unit 13) or vibration output by vibrating the terminal device 10 rather than the screen output described above.

Note that, in the output control for the user interface, the presentation unit 15f needs to recognize the disposition position of the target antenna in the terminal device 10. More specifically, the presentation unit 15f needs to grasp in advance the disposition positions of the respective antennas AN1 to AN4 in the terminal device 10.

For example, when information indicating the disposition positions of the respective antennas AN1 to AN4 illustrated in FIG. 4 can be acquired, the presentation unit 15f can easily grasp the disposition positions of the respective antennas AN1 to AN4. However, the presentation unit 15f cannot always acquire the information concerning the disposition positions.

For this reason, the specifying unit 15e may also specify the disposition positions of the respective antennas AN1 to AN4 at predetermined timing. For example, the specifying unit 15e can specify the disposition positions of the respective antennas AN1 to AN4 based on the band information specified in Step S607. For example, when the terminal data includes information indicating an electric current distribution in the terminal device 10, the specifying unit 15e may specify the disposition positions of the respective antennas AN1 to AN4 based on the electric current distribution.

### 1-6. Examples of the User Interface

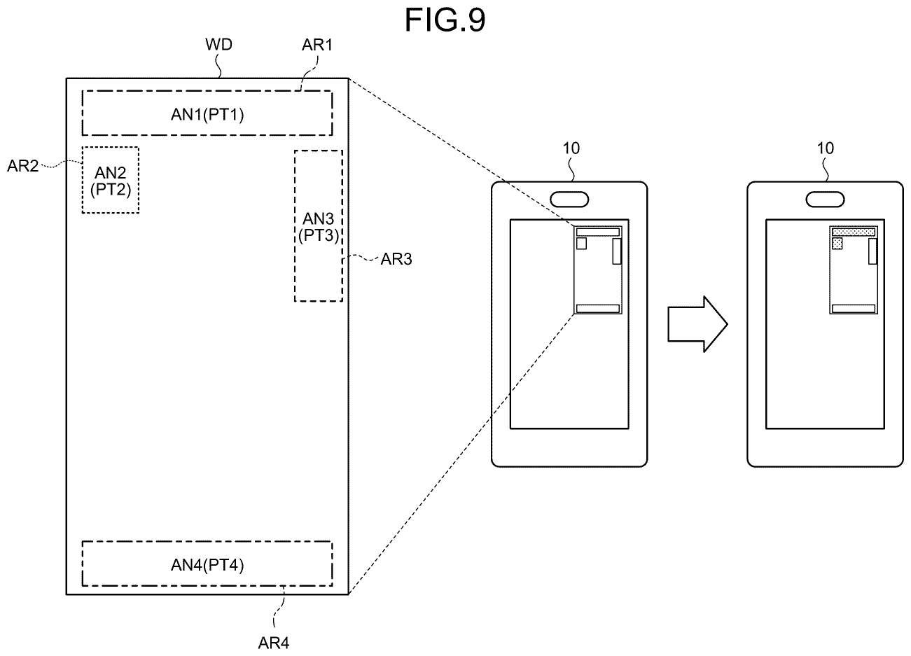

Examples of the user interface are explained below with reference to FIG. 9 to FIG. 11. Note that FIG. 9 to FIG. 11 illustrate output examples of the user interface in the case in which the antennas AN1 and AN2 are specified as target antennas.

### 1-6-1. Example (1) of the User Interface

FIG. 9 is a diagram (1) illustrating an example of the user interface. FIG. 9 illustrates an example in which, as the user interface, a window imitating the terminal device 10 and indicating disposition positions of the target antennas is output on the display screen.

For example, the presentation unit 15f may generate a window WD illustrated in FIG. 9 based on the disposition positions (from FIG. 4) of the respective antennas AN1 to AN4 in the terminal device 10. For example, the presentation unit 15f may generate the window WD indicating the range AR1, the range AR2, the range AR3, and the range AR4 as illustrated in FIG. 9 using the position P1, the position P2, the position P3, and the position P4.

In such a state, the presentation unit 15f controls the range AR1 corresponding to the antenna ANI specified as the target antenna and the range AR2 corresponding to the antenna AN2 specified as the target antenna to be in a visible state. As an example, the presentation unit 15f may paint out the range AR1 and the range AR2. The painted-out ranges AR1 and AR2 correspond to warning information for warning not to cover this position. Then, the presentation unit 15f causes the display screen of the terminal device 10 to display the window WD after the control as illustrated in FIG. 9.

With such output control, the user of the terminal device 10 can intuitively recognize that, in order to maintain communication performance without deteriorating the communication performance, the user needs to consciously perform operation not to cover the range AR1 and the range AR2 as much as possible. The user can recognize that the communication performance has been deteriorated because the user disturbs the communication by the antennas ANx.

Note that the presentation unit 15f may specify, based on information concerning the application APy in use, a position on the display screen estimated to less interfere with the operation of the application APy and display the window WD at the specified position. The presentation unit 15f may make the window WD transmissive or reduce the size of the window WD such that the application APy in use is not hidden by the window WD.

### 1-6-2. Example (2) of the User Interface

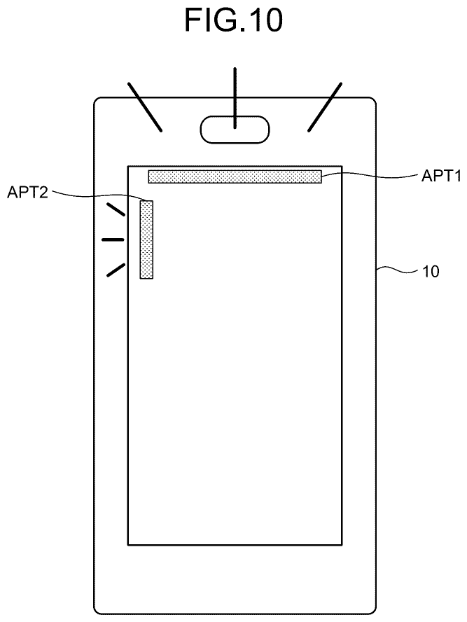

FIG. 10 is a diagram (2) illustrating an example of the user interface. FIG. 10 illustrates an example in which antenna position information indicating the disposition positions of the target antennas are output to the display screen as the user interface.

For example, as illustrated in FIG. 10, the presentation unit 15f may light up, based on the disposition positions (from FIG. 4) of the respective antennas AN1 to AN4 in the terminal device 10, the range ARI corresponding to the antenna AN1 specified as the target antenna. Similarly, as illustrated in FIG. 10, the presentation unit 15f may light up, based on the disposition positions (from FIG. 4) of the respective antennas AN1 to AN4 in the terminal device 10, the range AR2 corresponding to the antenna AN2 specified as the target antenna.

Note that the presentation unit 15f may light up only a part of the range AR1 not to disturb the application APy in use rather than lighting up the entire range AR1. Similarly, the presentation unit 15f may light up only a part of the range AR2 rather than lighting up the entire range AR2.

As explained above, alert using the lighting in the range AR1 is equivalent to the antenna position information suggesting the disposition position of the target antenna AN1 and alert using the lighting in the range AR2 is equivalent to the antenna position information suggesting the disposition position of the target antenna AN2.

### 1-6-3. Example (3) of the User Interface

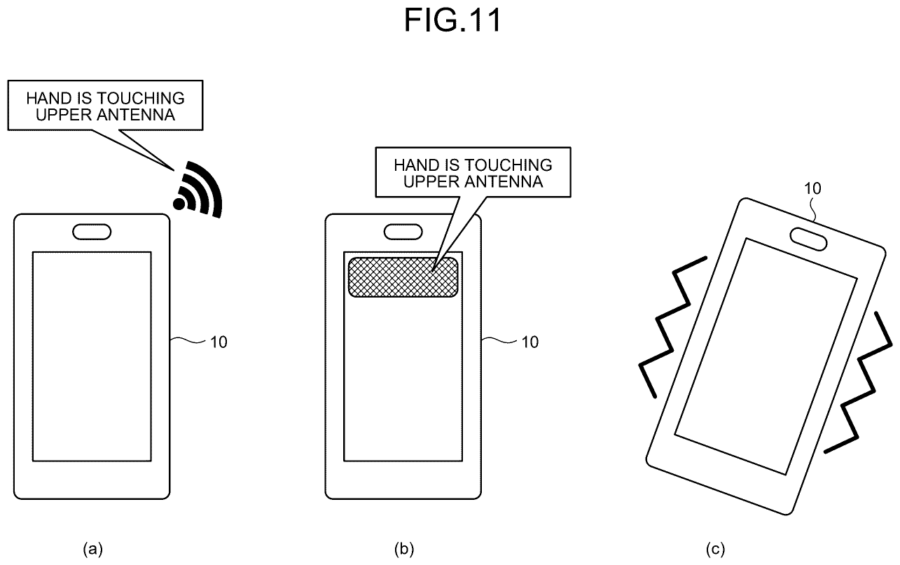

FIG. 11 is a diagram (3) illustrating an example of the user interface. For example, as illustrated in FIG. 11(a), the presentation unit 15f may cause the speaker to output voice information for alerting the positions of the target antennas.

As illustrated in FIG. 11(b), the presentation unit 15f may cause the display screen to output text information for alerting the positions of the target antennas. As illustrated in FIG. 11(c), the presentation unit 15f may vibrate the terminal device 10.

### 1-7. Output Stop of the User Interface

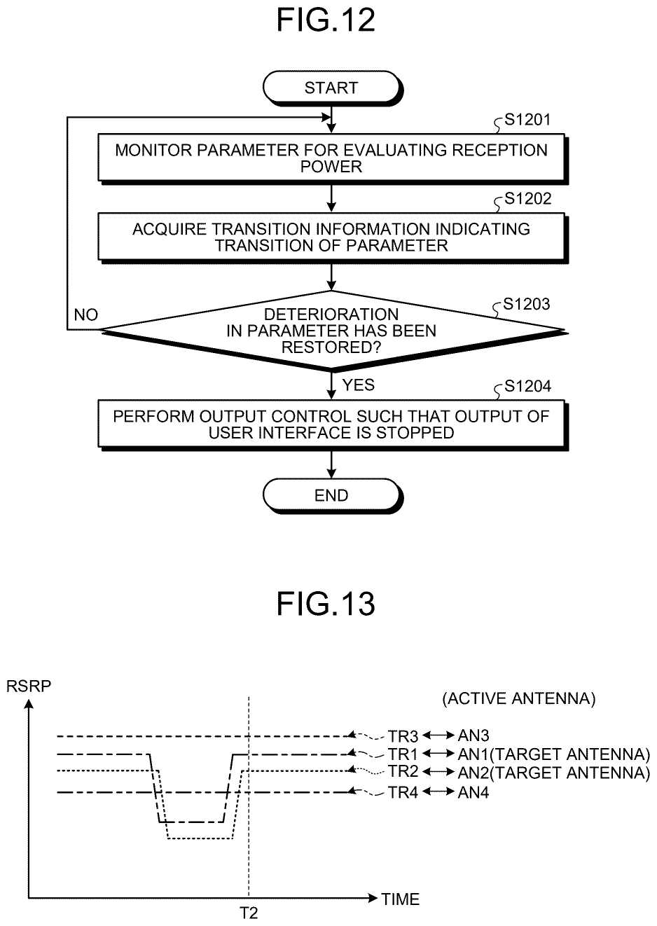

Subsequently, a procedure for stopping the output of the user interface is explained with reference to FIG. 12. FIG. 12 is a flowchart illustrating a control procedure relating to output stop of the user interface.

For example, while the user interface is output, the detection unit 15c continuously monitors the parameter (for example, the RSRP) for evaluating the reception level of the radio wave by the antennas ANx (Step S1201). The detection unit 15c acquires transition information indicating transition of the parameter according to the monitoring of the parameter (Step S1202).

Subsequently, the detection unit 15c determines, based on the transition information, whether the deterioration in the parameter detected so far has been restored (Step S1203). While the deterioration in the parameter has not been restored (Step S1203; No), the detection unit 15c repeats the processing from Step S1201 until the deterioration in the parameter is restored.

On the other hand, when the deterioration in the parameter has been restored (Step S1203; Yes), the presentation unit 15f performs output control such that the output of the user interface is stopped (Step S1204).

Here, a method of determining whether the deterioration in the parameter has been restored is explained with reference to FIG. 13. FIG. 13 is an explanatory diagram for explaining a parameter restoration determination method. FIG. 13 illustrates a restoration determination method for stopping the user interface output according to the example illustrated in FIG. 7(a).

According to an example illustrated in FIG. 13, in a specific section including time T2 later than the time T1, a rising tendency of the transition information TR1 and TR2 that has been deteriorating is seen. It is assumed that a degree of this rising tendency is equal to or greater than a threshold. In such a case, the detection unit 15c may detect the restoration of the RSRP with respect to the transition information TR1 and detect the restoration of the RSRP with respect to the transition information TR2 and, as a result, may determine that the deterioration in the parameter has been restored.

Note that, when approximation of the transition pattern of the transition information TR1 with respect to the transition patterns of the transition information TR3 and the transition information TR4 has been successfully detected, the detection unit 15c may determine that the deterioration in the parameter has been restored. Similarly, when approximation of the transition pattern of the transition information TR2 with respect to the transition patterns of the transition information TR3 and the transition information TR4 has been successfully detected, the detection unit 15c may determine that the deterioration in the parameter has been restored.

### Second Embodiment

### 2-1. System Configuration

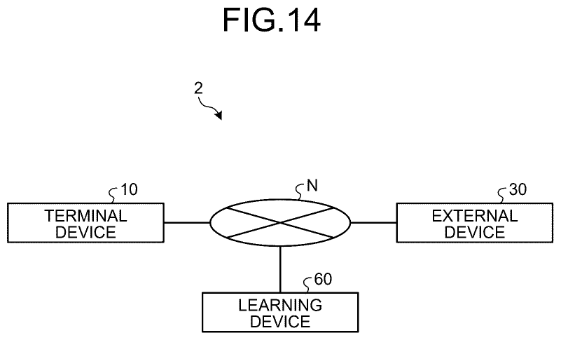

FIG. 14 is a diagram illustrating a configuration of a system according to a second embodiment. FIG. 14 illustrates an information processing system 2 as an example of the system according to the second embodiment.

According to the example illustrated in FIG. 14, the information processing system 2 further includes a learning device 60 compared with the information processing system 1 according to the first embodiment. The terminal device 10, the external device 30, and the learning device 60 may be communicably connected by wire or radio via the network N.

Here, using, as learning data, a combination of transition information in which deterioration in a parameter is detected and a factor known in advance as a factor of such transition information being obtained, the learning device 60 learns a model for estimating a factor of the deterioration in the parameter. For example, when certain transition information in which the deterioration in the parameter is detected this time is input as transition information of a target for which a factor is estimated, the learning device 60 learns a model to output information concerning the factor of the deterioration in the parameter.

### 2-2. Example of a Learning Method

The learning device 60 executes predetermined machine learning using learning data including, as an explanatory variable, transition information in which deterioration in a parameter is detected and a factor of the deterioration is known and including the factor of the deterioration as an objective variable. For example, when transition information in which deterioration in a parameter is detected and a factor of the deterioration is unknown (transition information of a target for which a factor is estimated) is input, the learning device 60 learns a model to output information concerning the factor of the deterioration.

For example, generation of a model may be performed using a technology concerning machine learning of supervised learning such as an SVM (Support Vector Machine). For example, the generation of the model may be performed using a deep learning technology. For example, the generation of the model may be performed by using various deep learning technologies such as DNN (Deep Neural Network), RNN (Recurrent Neural Network), and CNN (Convolutional Neural Network as appropriate.

Note that the learning device 60 may generate a model also using various pieces of terminal data as explanatory variables. The learning device 60 may classify the applications APy installed in the terminal device 10 by type and generate a model for each classification. For example, the learning device 60 may generate a model for each classification by classifying the applications APy installed in the terminal device 10 into a game application, a navigation application, a browser, and the like. As explained above, when a model is generated for each classification, the learning device 60 preferably uses appropriate terminal data corresponding to the classification as learning data. In the following explanation, this example is explained.

For example, when the game application is used, in some case, the terminal device 10 is used in a horizontally held state or the direction of the terminal device 10 is frequently changed to various directions. For this reason, a correlation is sometimes obtained between the game application and the direction of the terminal device 10. Therefore, when a model corresponding to the game application is generated, the learning device 60 may use, as learning data, detection information by a gyro sensor, application in use information, or the like serving as terminal data.

The navigation application is assumed to be used while moving or used in a place where deterioration in communication performance is likely to occur (for example, in a high altitude place or in a tunnel). Therefore, when generating a model corresponding to the navigation application, the learning device 60 may use, as learning data, for example, detection information by an acceleration sensor, detection information by an atmospheric pressure sensor, detection information by a GPS sensor, or the like serving as terminal data that is considered to be important under such an environment.

The browser is also assumed to be used while moving or in a place where deterioration of communication performance is likely to occur (for example, in the interior of a transportation facility or in a bathroom.). Therefore, when generating a model corresponding to the browser, the learning device 60 may use, as learning data, for example, detection information by the acceleration sensor, detection information by the atmospheric pressure sensor, detection information by the GPS sensor, or the like serving as terminal data that is considered to be important under such an environment.

It is explained above that the learning device 60 learns the model to output the information concerning the factor of the deterioration. However, for example, when a gripping state in a mode of disturbing the communication by the antennas ANx is estimated as the factor of the deterioration, a model may be learned to also estimate the gripping state, that is, a way of holding (or a way of touching). In this case, for example, the learning device 60 may use, as learning data, a pattern of a way of holding at the time when transition information in which deterioration in a parameter is detected and a factor of the deterioration is known is obtained.

For example, when certain transition information in which deterioration in a parameter has been detected this time is input as transition information of a target for which a factor is estimated, the learning device 60 learns a model to output information concerning a factor of the deterioration in the parameter and information indicating a pattern of a way of holding. For example, the learning device 60 may learn a model to output, as the information indicating the pattern of the way of holding, information indicating how the terminal device 10 is held in which direction.

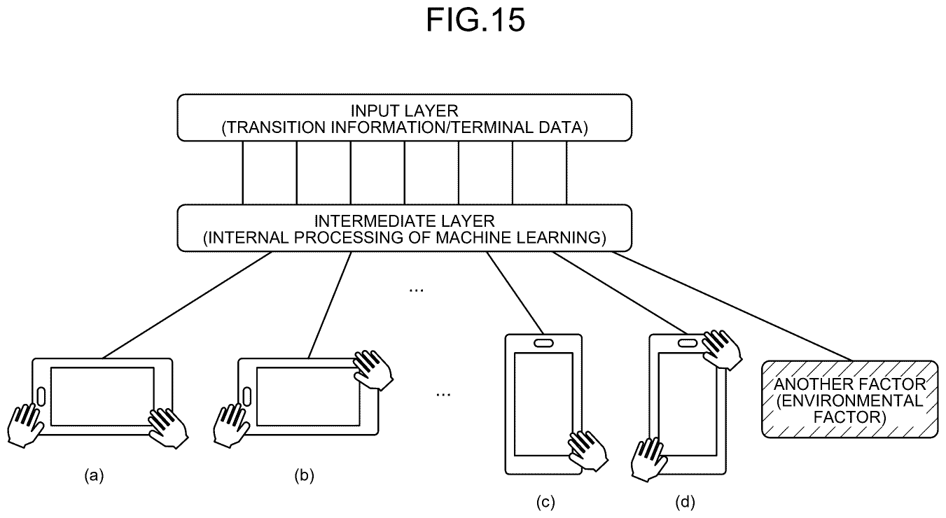

Here, FIG. 15 illustrates an example of a model learning method for estimating a pattern of a way of holding According to the example illustrated in FIG. 15, the model includes, for example, an input layer to which transition information and terminal data are input as learning data, an intermediate layer (a hidden layer) that performs an arithmetic operation based on characteristics of input information as internal processing of machine learning, and an output layer that outputs output information corresponding to an output of the intermediate layer.

According to the example illustrated in FIG. 15, an example is illustrated in which output information in the output layer is one of a direction of the terminal device 10 and a pattern (a) of a way of holding in the direction ((horizontal), a direction (horizontal) of the terminal device 10 and a pattern (b) of a way of holding in the direction, a direction (vertical) of the terminal device 10 and a pattern (c) of a way of holding in the direction, and a direction (vertical) of the terminal device 10 and a pattern (d) of a way of holding in the direction (vertical). When the output information in the output layer belongs to none of the patterns explained above, another factor (for example, an environmental factor) unrelated to the way of holding can be estimated as a factor of the deterioration in the parameter.

As illustrated in FIG. 14, when the learning device 60 is implemented as a server device independent of the terminal device 10, the terminal device 10 may acquire, from the learning device 60, the model generated by the learning device 60 with the method explained above and utilize the model for the estimation processing. On the other hand, the learning device 60 may be implemented as a module. In such a case, the terminal device 10 may perform not only inference using the model but also learning of a model by being equipped with the learning device 60.

### 2-3. Procedure of the Estimation Processing

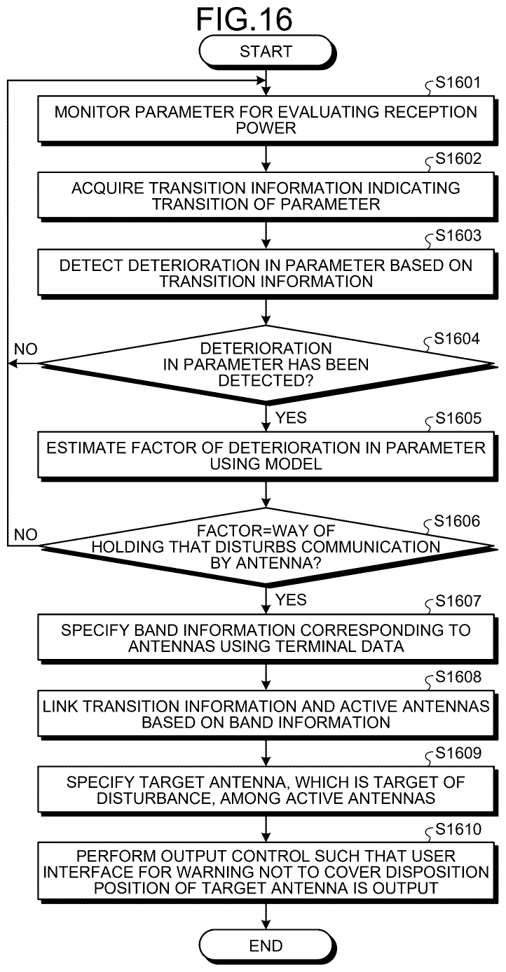

Subsequently, a procedure of the estimation processing using a model is explained with reference to FIG. 16. FIG. 16 is a flowchart illustrating an estimation processing procedure according to the second embodiment. Note that estimation processing illustrated in FIG. 16 may also be executed according to the result of the preprocessing illustrated in FIG. 5.

The detection unit 15c monitors a parameter (for example, an RSRP) for evaluating a reception level of a radio wave by the antennas ANx (Step S1601). The detection unit 15c acquires transition information indicating transition of the parameter according to the monitoring of the parameter (Step S1602).

Next, the detection unit 15c detects the deterioration in the parameter based on the transition information (Step S1603). The detection unit 15c determines whether the deterioration in the parameter has been detected (Step S1604). While deterioration in the parameter has not been detected (Step S1604; No), the detection unit 15c repeats the processing from Step S1601 until deterioration in the parameter is detected.

On the other hand, when the deterioration in the parameter is detected (Step S1604; Yes), the estimation unit 15d executes the estimation processing of estimating a factor of the deterioration in the parameter using the learned model (Step S1605). For example, when the example illustrated in FIG. 7(a) is used, the estimation unit 15d inputs the transition information TR1 to TR4 to the model and estimates, based on output information by the model, a factor of occurrence of the deterioration in the RSRP is detected only in the transition information TR1 and TR2.

The estimation unit 15d determines, based on an estimation result, whether a gripping state in a mode of disturbing the communication by the antennas ANx is a factor of the deterioration in the parameter (Step S1606). When determining that the gripping state in the mode of disturbing the communication by the antennas ANx is not a factor of the deterioration in the parameter (Step S1606; No), the estimation unit 15d repeats the processing from Step S1601.

On the other hand, when it is determined that the gripping state in the mode of disturbing the communication by the antenna ANx is a factor of the deterioration in the parameter, the specifying unit 15e specifies band information (a frequency band) corresponding to the respective antennas AN1 to AN4 based on the terminal data (Step S1607).

The specifying unit 15e links active antennas, which are antennas used for current communication, among the antennas AN1 to AN4 and the transition information TR1 to TR4 based on the band information and the terminal data (Step S1608).

Subsequently, the specifying unit 15e specifies a target antenna, which is a target of disturbance among the active antennas based on a linkage result in Step S1608 (Step S1609). When the example illustrated in FIG. 8 is used, the specifying unit 15e specifies, as the target antenna, the antenna AN1 linked as the active antenna with the transition information TR1 in which a pattern indicating the deterioration in the parameter (the RSRP) is detected. The specifying unit 15e specifies, as the target antenna, the antenna AN1 linked as the active antenna with the transition information TR2 in which the pattern indicating the deterioration in the parameter (the RSRP) is detected.

Subsequently, the presentation unit 15f performs output control such that a user interface for warning not to cover the disposition position of the target antenna in the terminal device 10 is output (Step S1610). The output control examples are as explained with reference to FIG. 9 to FIG. 11.

### 2-4. Estimation of a Way of Holding and Proposal of a Way of Holding Corresponding to an Estimation Result

For example, determining in Step S606 that the gripping state in the mode of disturbing the communication by the antennas ANx is the factor of the deterioration in the parameter, the estimation unit 15d may estimate this gripping state as well using the learned model. That is, the estimation unit 15d may estimate how the terminal device 10 is held to deteriorate the parameter and a way of holding causing the deterioration.

The presentation unit 15f compares a way of holding indicated by an estimation result and a recommended method that is a way of holding the terminal device 10 recommended for the application APy used at this time. Then, when the way of holding indicated by the estimation result and the recommended method are different, the presentation unit 15f proposes this recommended method to the user.

### Another Embodiment (1)

In the first embodiment, a method of detecting a difference by comparing patterns of transition information and estimating a factor of deterioration in a parameter based on a detection result is explained. In the second embodiment, a method of estimating a factor of deterioration in a parameter using a machine learning model is explained.

However, the estimation unit 15d may adopt a so-called autocorrelation method of estimating a factor of deterioration in a parameter based on whether continuous data of the parameter is mathematically similar to a specific pattern (a specific way of holding). The estimation unit 15d may adopt so-called maximum likelihood estimation for repeatedly calculating parameter continuous data until reaching a certain optimum value to estimate a factor of deterioration in a parameter based on whether time-series data of the parameter converges to data of a specific pattern (a specific way of holding).

The estimation unit 15d may determine an optimum estimation method for a type of the application APy started in the terminal device 10 and estimate a factor of deterioration in a parameter with the estimation method. For example, when the application APy in use is a game application in a tendency to have a large processing load, the estimation unit 15d may adopt an estimation method using a model. Since the estimation method using the model has a relatively small processing load and a short calculation time, it is considered that the estimation method is compatible with the game application having the large processing load.

When the application APy in use is a navigation application, the estimation unit 15d may adopt the estimation method using the model. For example, the navigation application is often in a situation of being used while moving outside. It is assumed that communication performance continuously changes because of handover. For this reason, the estimation technique using the model is considered to be more compatible with the navigation application compared with other estimation techniques by algorithms.

When the application APy in use is a browser, the estimation unit 15d may adopt the maximum likelihood estimation. For example, since the communication performance is not regarded as important while content is browsed via the browser, it is possible to perform estimation for a certain degree of time. For this reason, it is considered that the maximum likelihood estimation having a relatively long calculation time required for estimation and, on the other hand, having high estimation accuracy is considered to be compatible with the browser.

### Another Embodiment (2)

The presentation unit 15f may determine an optimum output scheme for a type of the application APy started in the terminal device 10 and output a user interface with the determined output scheme.

For example, when the application APy in use is a game application, the presentation unit 15f may output a user interface in a voice format or a vibration format. As a result, the presentation unit 15f can take measures such that the application APy in use is not disturbed by the user interface.

When the application APy in use is a navigation application, the presentation unit 15f may output a user interface by a display format (for example, the window WD or lighting).

Furthermore, in a case where the application APy in use is a navigation application, the presentation unit 15f may output the user interface in a voice format or a vibration format. Accordingly, the presentation unit 15f can take measures against bothersome feeling caused by display of the user interface for a long time.

### Another Embodiment (3)

When an antenna different from an antenna currently specified as a target antenna according to switching of an active antenna corresponding to communication is specified as a new target antenna, the presentation unit 15f may update output of a user interface based on a disposition position of the new target antenna.

For example, there are various types of the antennas ANx corresponding to uses. A combination of active antennas is sometimes severally changed according to a situation of the user. As an example, when the terminal device 10 is used for near field communication, there is a case in which the antenna AN1 and the antenna AN3 are used to be active antennas and, on the other hand, only the antenna AN4 is an active antenna because communication is performed in the 4G standard in normal time. There is also a case in which the combination of active antennas is changed by handover.

As explained above, when the active antennas are switched according to communication content, the target antennas also sometimes change according to the switching. Therefore, when a new target antenna is specified, the presentation unit 15f may also update the output of the user interface based on a disposition position of the new target antenna.

For example, in FIG. 9, the presentation unit 15f controls the range AR1 corresponding to the antenna AN1 specified as the target antenna and the range AR2 corresponding to the antenna AN2 specified as the target antenna to be in a visible state. However, when the antenna AN4 is specified as the target antenna in a state in which the antennas AN1 and AN2 become inactive and the antennas AN3 and AN4 become active antennas anew, the presentation unit 15f may control the range AR4 corresponding to the antenna AN4 to be in a visible state again.

Note that, when a frequency of a new target antenna being specified exceeds a predetermined frequency, the presentation unit 15f may not update the output of the user interface. For example, if the user interface is frequently updated, this sometimes hinders the use of the application APy. However, the usability of the application APy can be maintained by such processing.

### Another Embodiment (4)

In the embodiments explained above, the example is explained in which, when deterioration in a parameter is detected, the estimation unit 15d executes the estimation processing of estimating a factor of the deterioration in the parameter based on transition information and, therefore, the presentation unit 15f outputs a user interface when a gripping state in a mode of disturbing communication by antennas is estimated as the factor of the deterioration in the parameter. However, the factor estimation based on the transition information may be skipped. In such a case, the presentation unit 15f may output the user interface in response to detection of the deterioration in the parameter.

### Hardware configuration Example

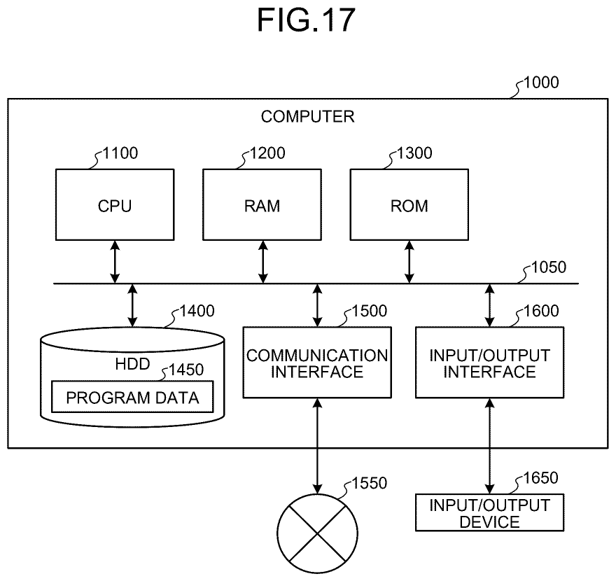

A hardware configuration example of a computer corresponding to the terminal device 10 (the information processing device) according to the embodiment is explained with reference to FIG. 17. FIG. 17 is a block diagram illustrating a hardware configuration example of a computer corresponding to the terminal device 10 according to the embodiment of the present disclosure. Note that FIG. 17 illustrates an example of a hardware configuration of the computer corresponding to the terminal device 10 according to the embodiment of the present disclosure. The hardware configuration does not need to be limited to the configuration illustrated in FIG. 17.

As illustrated in FIG. 25, a computer 1000 includes a CPU (Central Processing Unit) 1100, a RAM (Random Access Memory) 1200, a ROM (Read Only Memory) 1300, a HDD (Hard Disk Drive) 1400, a communication interface 1500, and an input/output interface 1600. The units of the computer 1000 are connected by a bus 1050.

The CPU1100 operates based on a program stored in the ROM1300 or the HDD1400 and controls the units. For example, the CPU1100 loads the program stored in the ROM1300 or the HDD1400 in the RAM1200 and executes processing corresponding to various programs.

The ROM 1300 stores a boot program such as a BIOS (Basic Input Output System) executed by the CPU 1100 at a start time of the computer 1000, a program depending on hardware of the computer 1000, and the like.

The HDD1400 is a computer-readable recording medium that non-transiently records a program to be executed by the CPU1100, data to be used by the program, and the like. Specifically, the HDD1400 records program data 1450. The program data 1450 is an example of an information processing program for implementing the information processing method according to the embodiment of the present disclosure and data used by the information processing program according to the embodiment.

The communication interface 1500 is an interface for the computer 1000 to be connected to an external network 1550 (for example, the Internet). For example, the CPU 1100 receives data from other equipment and transmits data generated by the CPU 1100 to the other equipment via the communication interface 1500.

The input/output interface 1600 is an interface for connecting an input/output device 1650 and the computer 1000. For example, the CPU1100 receives data from an input device such as a keyboard or a mouse via the input/output interface 1600. The CPU1100 transmits data to an output device such as a display device, a speaker, or a printer via the input/output interface 1600. The input/output interface 1600 may function as a media interface that reads a program or the like recorded in a predetermined recording medium (a medium). The medium is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, a semiconductor memory, or the like.

For example, when the computer 1000 functions as the terminal device 10 according to the embodiment of the present disclosure, the CPU1100 of the computer 1000 implements various processing functions executed by the units of the control unit 15 illustrated in FIG. 3 by executing an information processing program loaded on the RAM1200. That is, the CPU1100, the RAM1200, and the like implement an information processing method by the terminal device 10 according to the embodiment of the present disclosure in cooperation with software (the information processing program loaded on the RAM 1200).

### SUMMARY

Although the embodiment of the present disclosure is explained above, the technical scope of the present disclosure is not limited to the embodiment explained above per se. Various changes are possible without departing from the gist of the present disclosure. The components in the embodiment and the modifications may be combined as appropriate.

The effects in the embodiments explained in this specification are only illustrations and are not limited. Other effects may be present.

Note that the present disclosure can also take configurations explained below.
(1) An information processing device comprising:
   a detection unit that detects deterioration in a parameter for evaluating reception intensity by an antenna of the information processing device; and
   a presentation unit that, when the deterioration in the parameter is detected, presents information concerning gripping of the information processing device according to the deterioration in the parameter.
(2) The information processing device according to the above (1), further comprising
   a specifying unit that specifies a target antenna, which is a target of the deterioration in the parameter, out of active antennas that are antennas used for current communication among the antennas, wherein
   the presentation unit outputs a user interface for warning not to cover a disposition position of the target antenna.
(3) The information processing device according to the above (2), wherein
   the presentation unit outputs, as the user interface, a window imitating the information processing device and indicating the disposition position of the target antenna to a predetermined position on a display screen of the information processing device.
(4) The information processing device according to the above (2), wherein
   the presentation unit outputs, as the user interface, antenna position information indicating the disposition position of the target antenna to a position near the disposition position of the target antenna among positions in a display screen of the information processing device.
(5) The information processing device according to the above (2), wherein,
   when an antenna different from an antenna currently specified as the target antenna is specified as a new target antenna according to switching of an active antenna corresponding to communication, the presentation unit updates output of the user interface based on a disposition position of the new target antenna.
(6) The information processing device according to the above (5), wherein,
   when a frequency of the new target antenna being specified exceeds a predetermined frequency, the presentation unit does not update the output of the user interface.
(7) The information processing device according to the above (2), wherein
   the presentation unit determines an output scheme of the user interface according to a type of an application program started in the information processing device and outputs the user interface in the determined output scheme.
(8) The information processing device according to the above (2), wherein
   the specifying unit further specifies a disposition position of the antenna in the information processing device based on information concerning a characteristic of the antenna or information concerning an electric current distribution in the information processing device.
(9) The information processing device according to the above (2), wherein
   the presentation unit stops the presentation of the user interface when it is determined, based on the change in the parameter, that the deterioration in the parameter has been improved.
(10) The information processing device according to the above (1), wherein,
   when a way of holding the information processing device recommended when an application program started in the information processing device is used and a way of holding the information processing device by a user, the way of holding being estimated based on predetermined data acquired by the information processing device, are different, the presentation unit presents the recommended way of holding the information processing device.
(11) The information processing device according to the above (1), further comprising
   an estimation unit that, when the deterioration in the parameter is detected, estimates a factor of the deterioration in the parameter based on information concerning the parameters corresponding to a respective plurality of antennas included in the information processing device.
(12) The information processing device according to the above (11), wherein
   the estimation unit estimates, based on a model generated by using, as learning data, a combination of information concerning the parameters corresponding to the respective plurality of antennas and a factor estimated from the information, a factor of deterioration in a parameter detected this time.
(13) The information processing device according to the above (11), wherein,
   when estimating, as a factor of the deterioration in the parameter, a gripping state in a mode of disturbing communication by the antenna, the estimation unit executes processing for presenting information concerning gripping of the information processing device.
(14) The information processing device according to the above (11), wherein,
   when a factor of the deterioration in the parameter is not a gripping state in a mode of disturbing communication by the antenna, the estimation unit does not execute processing for presenting information concerning gripping of the information processing device.
(15) An information processing method executed by an information processing device, the information processing method comprising:
   a detection step of detecting deterioration in a parameter for evaluating reception intensity by an antenna of the information processing device; and
   a presentation step of, when the deterioration in the parameter is detected, presenting information concerning gripping of the information processing device according to a factor of the deterioration in the parameter.

### REFERENCE SIGNS LIST

1 INFORMATION PROCESSING SYSTEM
2 INFORMATION PROCESSING SYSTEM
10 TERMINAL DEVICE
15 CONTROL UNIT
15a ACQUISITION UNIT
15b PREPROCESSING UNIT
15c DETECTION UNIT
15d ESTIMATION UNIT
15e SPECIFYING UNIT
15f PRESENTATION UNIT
ANx ANTENNA
ACy APPLICATION CONTROL UNIT

1. An information processing device comprising:
a detection unit that detects deterioration in a parameter for evaluating reception intensity by an antenna of the information processing device; and
a presentation unit that, when the deterioration in the parameter is detected, presents information concerning gripping of the information processing device according to the deterioration in the parameter.

2. The information processing device according to claim 1, further comprising
a specifying unit that specifies a target antenna, which is a target of the deterioration in the parameter, out of active antennas that are antennas used for current communication among the antennas, wherein
the presentation unit outputs a user interface for warning not to cover a disposition position of the target antenna.

3. The information processing device according to claim 2, wherein
the presentation unit outputs, as the user interface, a window imitating the information processing device and indicating the disposition position of the target antenna to a predetermined position on a display screen of the information processing device.

4. The information processing device according to claim 2, wherein
the presentation unit outputs, as the user interface, antenna position information indicating the disposition position of the target antenna to a position near the disposition position of the target antenna among positions in a display screen of the information processing device.

5. The information processing device according to claim 2, wherein,
when an antenna different from an antenna currently specified as the target antenna is specified as a new target antenna according to switching of an active antenna corresponding to communication, the presentation unit updates output of the user interface based on a disposition position of the new target antenna.

6. The information processing device according to claim 5, wherein,
when a frequency of the new target antenna being specified exceeds a predetermined frequency, the presentation unit does not update the output of the user interface.

7. The information processing device according to claim 2, wherein
the presentation unit determines an output scheme of the user interface according to a type of an application program started in the information processing device and outputs the user interface in the determined output scheme.

8. The information processing device according to claim 2, wherein
the specifying unit further specifies a disposition position of the antenna in the information processing device based on information concerning a characteristic of the antenna or information concerning an electric current distribution in the information processing device.

9. The information processing device according to claim 2, wherein
the presentation unit stops the presentation of the user interface when it is determined, based on the change in the parameter, that the deterioration in the parameter has been improved.

10. The information processing device according to claim 1, wherein,
when a way of holding the information processing device recommended when an application program started in the information processing device is used and a way of holding the information processing device by a user, the way of holding being estimated based on predetermined data acquired by the information processing device, are different, the presentation unit presents the recommended way of holding the information processing device.

11. The information processing device according to claim 1, further comprising
an estimation unit that, when the deterioration in the parameter is detected, estimates a factor of the deterioration in the parameter based on information concerning the parameters corresponding to a respective plurality of antennas included in the information processing device.

12. The information processing device according to claim 11, wherein
the estimation unit estimates, based on a model generated by using, as learning data, a combination of information concerning the parameters corresponding to the respective plurality of antennas and a factor estimated from the information, a factor of deterioration in a parameter detected this time.

13. The information processing device according to claim 11, wherein,
when estimating, as a factor of the deterioration in the parameter, a gripping state in a mode of disturbing communication by the antenna, the estimation unit executes processing for presenting information concerning gripping of the information processing device.

14. The information processing device according to claim 11, wherein,
when a factor of the deterioration in the parameter is not a gripping state in a mode of disturbing communication by the antenna, the estimation unit does not execute processing for presenting information concerning gripping of the information processing device.

15. An information processing method executed by an information processing device, the information processing method comprising:
a detection step of detecting deterioration in a parameter for evaluating reception intensity by an antenna of the information processing device; and
a presentation step of, when the deterioration in the parameter is detected, presenting information concerning gripping of the information processing device according to a factor of the deterioration in the parameter.
